(19) United States
(12) Patent Application Publication
(10) Pub. No.: US 2012/0127280 A1
(43) Pub. Date: May 24, 2012

(54) APPARATUS AND METHOD FOR GENERATING THREE DIMENSIONAL IMAGE IN PORTABLE TERMINAL

(75) Inventor: Dong-Hoon KIM, Seoul (KR)

(73) Assignee: SAMSUNG ELECTRONICS CO., LTD., Suwon-si (KR)

(21) Appl. No.: 13/299,321

(22) Filed: Nov. 17, 2011

(30) Foreign Application Priority Data
Nov. 22, 2010 (KR) 10-2010-0116015

(51) Int. Cl. H04N 13/02

(52) U.S. Cl. 348/50; 348/E13.074

(57) ABSTRACT

An apparatus for generating an image in a portable terminal includes a camera unit and an image generating unit. The camera unit is provided with a single camera module and configured to acquire a first image corresponding to a left viewpoint and a second image corresponding to one of a complementary right or left viewpoint. The image generating unit is configured to determine a photographing region of the second image corresponding to the complementary right or left viewpoint, based on the first image, and acquire the second image in the determined photographing region of the second image using the camera unit.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Nov. 22, 2010 and assigned Serial No. 10-2010-0116015, the contents of which are incorporated herein by reference.

### TECHNICAL FIELD OF THE INVENTION

The present invention relates generally to an apparatus and method for generating a three-dimensional (3D) image in a portable terminal, and more particularly to, an apparatus and method for acquiring a plurality of images having different viewpoints in a portable terminal with a single camera module.

### BACKGROUND OF THE INVENTION

The use of portable terminals is rapidly increasing due to their portability. Additionally, portable terminal manufacturers are competitively developing portable terminals with more convenient functions in order to attract more users. For example, portable terminals provide various functions such as a phone book, game, scheduler, short message service, multimedia message service, broadcast message service, Internet service, e-mail, wake-up call, MP3, and digital camera functions.

Extensive research has recently been conducted on a method for generating a 3D image on a portable terminal. It aims at expressing image information more realistically and with more realism than previously accomplished with conventional portable terminals. To this end, using human's visual characteristic, a left-viewpoint image and a right-viewpoint image are projected on pertinent positions of an existing display device, and the left-viewpoint image and the right-viewpoint image are formed separately on a user's left eye and right eye such that the user feels a 3D effect. As an example, a portable terminal with a barrier liquid crystal display (LCD) (e.g., a 3D portable terminal, a 3D camera, a 3D camcorder, and the like) can provide a more realistic image to a user by reproducing stereoscopic contents.

In the case of using stereo vision technology, the portable terminal synthesizes two images acquired using two camera modules, and generates an image that provides a 3D effect. However, the use of two camera modules often leads to increased production costs.

As another method, a method for generating two images having different viewpoints using one frame of image, and a method for providing a 3D effect using previous data and next data in moving picture data have been suggested. However, these methods require a large amount of computation and may not provide a natural 3D effect.

Therefore, there is a need for a method and apparatus for acquiring an image to provide a 3D effect in a portable terminal with a single camera module.

### SUMMARY OF THE INVENTION

To address the above-discussed deficiencies of the prior art, it is an aspect of the present disclosure to provide an apparatus and method for acquiring a plurality of images having different viewpoints in a portable terminal with a single camera module.

Another aspect of the present disclosure is to provide an apparatus and method for determining a position for acquisition of an image having a different viewpoint using an actual distance between a portable terminal and a subject.

Another aspect of the present disclosure is to provide an apparatus and method for determining a distance between a portable terminal and a subject using a lens movement distance according to an Auto Focus (AF) function.

In accordance with an aspect of the present disclosure, an apparatus for generating an image in a portable terminal is provided. The apparatus includes a camera unit provided with a single camera module and configured to acquire a first image corresponding to a left viewpoint and a second image corresponding to a right viewpoint; and an image generating unit configured to determine a photographing region of the second image corresponding to the right viewpoint based on the first image, and acquire the second image in the determined photographing region of the second image using the camera unit.

In accordance with another aspect of the present disclosure, a method for generating a 3D image in a portable terminal is provided. The method includes acquiring a first image corresponding to a left viewpoint using a single camera module; determining a photographing region of a second image corresponding to a right viewpoint, based on the first image; and acquiring the second image in the determined photographing region of the second image.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of the present disclosure will become more apparent from the following detailed description when taken in conjunction with the accompanying drawings in which:

FIG. 1 illustrates an example portable terminal that generates a 3D image using a single camera according to an embodiment of the present disclosure;

FIG. 2 illustrates an example process of generating a 3D image in a portable terminal according to an embodiment of the present disclosure;

FIG. 3 illustrates an example process of determining an actual distance between a portable terminal and a subject according to an embodiment of the present disclosure;

FIG. 4 illustrates an example process of photographing a first image and a second image to generate a 3D image providing a 3D effect in a portable terminal according to an embodiment of the present disclosure; and

FIGS. 5A and 5B illustrate example images that are photographed for providing a 3D effect in the portable terminal according to an embodiment of the present disclosure.

Throughout the drawings, like reference numerals will be understood to refer to like parts, components and structures.

### DETAILED DESCRIPTION OF THE INVENTION

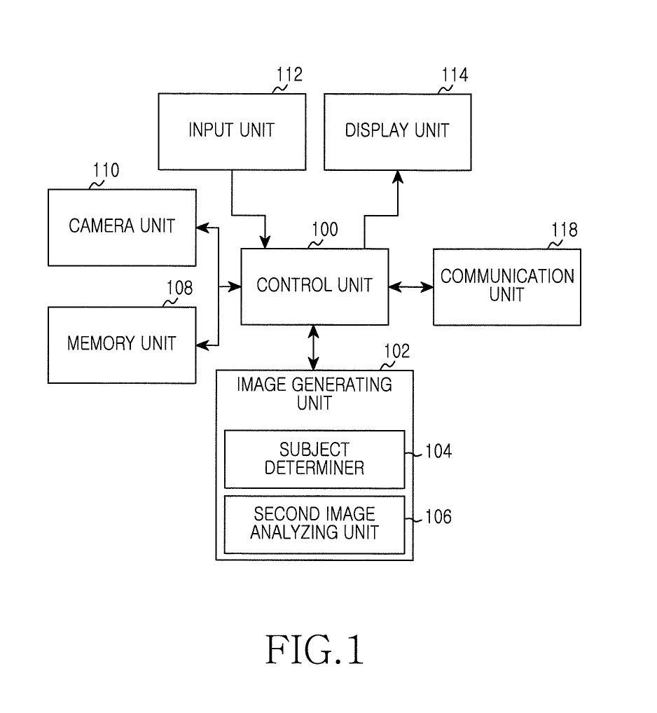

FIGS. 1 through 5B, discussed below, and the various embodiments used to describe the principles of the present disclosure in this patent document are by way of illustration only and should not be construed in any way to limit the scope of the disclosure.

FIG. 1 illustrates an example structure of a portable terminal that generates a 3D image using a single camera according to an embodiment of the present disclosure.

Referring to FIG. 1, the portable terminal may include a control unit 100, an image generating unit 102, a memory unit 108, a camera unit 110, an input unit 112, a display unit 114, and a communication unit 116. The image generating unit 102 may include a subject determiner 104 and a second image analyzing unit 106.

The control unit 100 of the portable terminal controls an overall operation of the portable terminal For example, the control unit 100 processes and controls voice call and data communication. In addition, the control unit 100 acquires an second image capable of providing a 3D effect, based on a first image acquired using a single camera module.

At this time, the control unit 100 determines a position for acquisition of the second image using an actual distance between the portable terminal and a subject contained in the first image.

Under the control of the control unit 100, the image generating unit 102 acquires the first image and the second image for providing a 3D effect to generate a 3D image.

The images acquired by the image generating unit 102 may include a plurality of images that are acquired using the camera unit 110 with a single camera module, and they are substantially identical to images that are photographed at different viewpoints with respect to the same subject.

The image generating unit 102 controls the subject determiner 104 to determined the actual distance between the portable terminal and the subject. The image generating unit 102 also and controls the second image analyzing unit 106 to determine the position for acquisition of the second image in which the position for acquisition of an image represents the same viewpoint as the images acquired by two cameras using the actual distance determined by the subject determiner 104. Under the control of the image generating unit 102, the subject determiner 104 determines the actual distance between the portable terminal and the subject using a distance to a lens that is moved according to a subject focus adjustment.

The memory unit 108 preferably includes, for example, a Read Only Memory (ROM), a Random Access Memory (RAM), a flash ROM, and the like. The ROM stores a variety of reference data and instructions of a computer executable program that may be used by the control unit 100 to process and control the image generating unit 102.

The RAM is a working memory of the control unit 100, which stores temporary data generated during the execution of various programs. The flash ROM stores a variety of updatable data such as phone numbers, outgoing messages, incoming messages, and such.

The camera unit 110 photographs a subject and stores a photographed subject image. The camera unit 110 provides an Auto Focus (AF) function. According to the AF function, the lens movement distance is used to determine the actual distance between the portable terminal and the subject.

The input unit 112 includes numeric keys of 0-9 and a plurality of function keys, such as a ‘Menu key’, a ‘Cancel key’, a ‘Confirmation key’, a ‘Talk key’, an ‘End key’, an ‘Internet Connection key’, one or more ‘Navigation keys’ or ‘direction keys’, one or more character input keys, and the like. The input unit 112 provides the control unit 100 with key input data that corresponds to a key pressed by a user.

The display unit 114 displays characters, moving pictures, still pictures, and status information generated during the operation of the portable terminal. The display unit 114 may be a color Liquid Crystal Display (LCD), Active Mode Organic Light Emitting Diode (AMOLED), and the like. The display unit 114 may be provided with a touch sensitive input device and be used as an input device when it is applied to a touch input type portable terminal.

The communication unit 116 transmits/receives Radio Frequency (RF) signals inputted/outputted through an antenna (not illustrated). For example, in a transmitting (TX) mode, the communication unit 116 channel-codes, spreads and radio frequency (RF)-processes transmission data prior to transmission. In a receiving (RX) mode, the communication unit 116 converts a received RF signal into a baseband signal and dispreads and channel-decodes the baseband signal to restore the original data.

The control unit 100 of the portable terminal may be configured to perform the functions of the image generating unit 102. The image generating unit 102 is separately illustrated for convenience of explanation and is merely exemplary. The present invention is not limited to the above exemplary structure. It is apparent to those skilled in the art that various modifications may be made within the scope of the present invention. For example, the control unit 100 may also be configured to perform all the functions of the separate units.

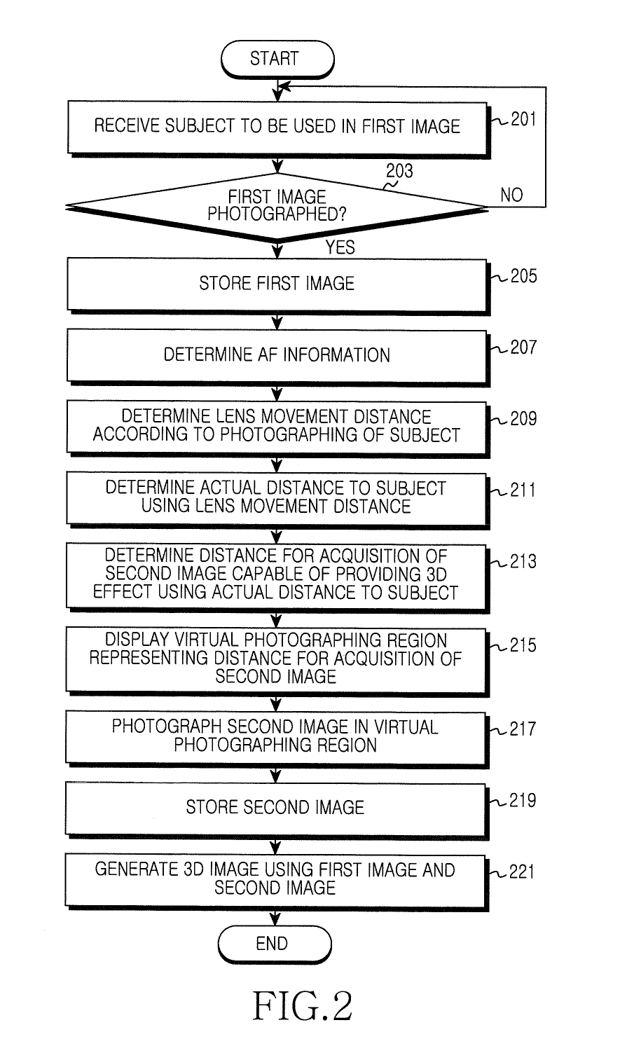

FIG. 2 illustrates an example process of generating a 3D image in a portable terminal according to an embodiment of the present disclosure.

Referring to FIG. 2, the portable terminal receives a subject to be used in a first image in step 201. That is, step 201 is to photograph the subject with the portable terminal and display the photographed subject on a preview screen.

The portable terminal proceeds to step 203 to determine whether a first image is photographed according to a user's request. The first image is one of a plurality of images required to generate a 3D image and is an image photographed based on a left viewpoint. If it is determined in step 203 that the first image is not photographed, the portable terminal returns to step 201. However, if it is determined in step 203 that the first image is photographed, the portable terminal photographs the subject displayed on the preview screen and proceeds to step 205 to store the photographed first image. At this time, the portable terminal includes the camera unit that additionally has the auto focus (AF) function, and auto focus information is stored together with the image upon photographing of the first image.

At step 207, the portable terminal determines the auto focus information of the first image. At step 209, the portable terminal determines a lens movement distance according to the photographing of the subject corresponding to the first image. That is, in step 209, the distance by which the lens is moved so as to automatically focus on the subject is determined using the auto focus information.

The portable terminal proceeds to step 211 to determine the actual distance between the portable terminal and the subject using the lens movement distance determined in step 209. The portable terminal may store a look-up table as defined in Table 1 below and determine the distance to the subject according to the lens movement distance.

TABLE 1

| Lens Movement Distance | Distance to Subject |
|---|---|
| 0.5 milimeters | 1 meter |
| 1 milimeter | 2 meters |
| 2 milimeters | 3 meters |

The case where the portable terminal photographs the subject located at a distance of 2 m represents that the position of the lens is moved by 1 mm so as to focus on the subject.

At step 213, the portable terminal determines a distance for acquisition of a second image that can provide a 3D effect together with the first image. The portable terminal uses a single camera module to acquire a plurality of images that provide a 3D effect in which the first image and the second image are generated by photographing the same subject at different photographing distances such that subject photographing angles become different. At this time, the portable terminal determines the distance for acquisition of the second image using position information of a look-up table as shown in Table 2 below.

TABLE 2

| Distance to Subject | Distance for Acquisition of Second Image |
|---|---|
| 1 meter | Move by 15 pixels |
| 2 meters | Move by 30 pixels |
| 3 meters | Move by 40 pixels |

That is, if it is determined that the distance to the subject is 1 meter, the portable terminal photographs the subject after moving the subject position by 15 pixels on the preview displayed upon acquisition of the first image. Hence, the portable terminal acquires substantially the same images as those acquired by a portable terminal with two camera modules.

The portable terminal displays a virtual photographing region on the preview screen at step 215. The virtual photographing region represents the distance for acquisition of the second image. Then, the portable terminal acquires the second image in the displayed virtual photographing region at step 217. The virtual photographing region refers to a region that guides the position for acquisition of the second image for providing the 3D effect in which the virtual photographing region is a photographing region that is displayed by moving the first image photographing region by the distance determined in step 213. The portable terminal may set the virtual photographing region by processing the first image translucently or displaying the boundary of the first image in dotted lines. Therefore, when the user of the portable terminal locates the subject in the virtual photographing region and photographs the subject, the user can acquire the first image and the second image generated by photographing the subject at different positions.

At this time, when the user of the portable terminal determines that the subject is located in the virtual photographing region, the user may acquire the second image by pressing a shutter release button, or may control the portable terminal to automatically acquire the second image so as to prevent a shake caused by a user. That is, the portable terminal monitors data inputted through the camera and automatically photographs the second image when it is determined by a block matching technique that the photographing region is matched according to a block-based similarity.

At step 219, the portable terminal stores the second image photographed in step 217, and generates the 3D image using the first image and the second image at step 221. At this time, the portable terminal extracts even rows of the image corresponding to a left viewpoint from the acquired image, and extracts odd rows of the image corresponding to a right viewpoint from the acquired image. Then, the portable terminal generates a single 3D image, encodes the single 3D image, and stores the encoded 3D image.

Although the foregoing method is described in which the first image includes a left viewpoint and the second image includes a right viewpoint, the portable terminal may also generate the first image comprising a right viewpoint and the second image comprising the left viewpoint.

Thereafter, the portable terminal ends the algorithm according to the embodiment of the present invention.

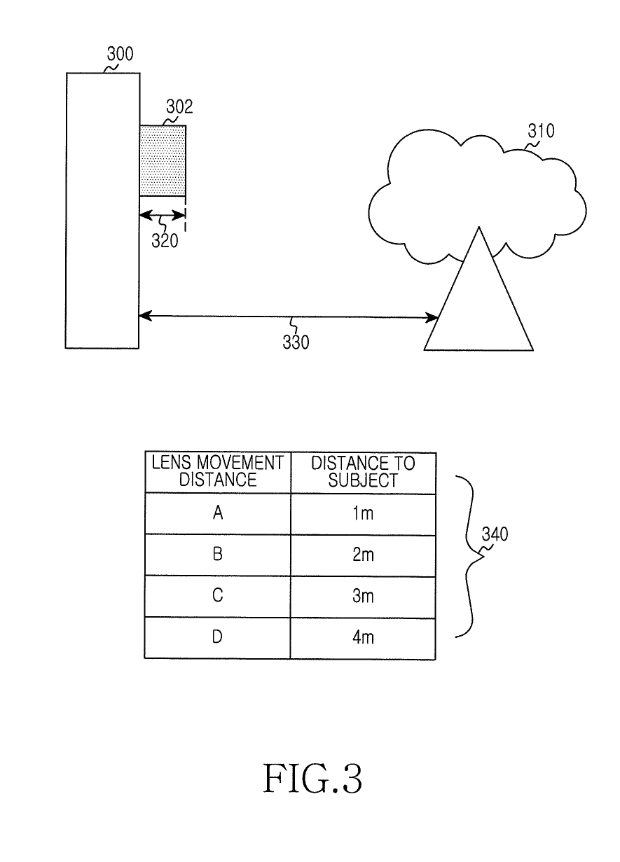

FIG. 3 illustrates an example process of determining an actual distance between a portable terminal and a subject according to an embodiment of the present disclosure.

Referring to FIG. 3, a portable terminal 300 is provided with a single camera 302 for generating a 3D image that provides a 3D effect using a plurality of images photographed by the camera.

In addition, the camera 302 of the portable terminal 300 has an AF function that focuses the portable terminal on the subject 310 by automatically moving a camera lens upon photographing. In one embodiment, the actual distance between the portable terminal 300 and the subject 310 can be determined according to the position of the moving lens.

As illustrated in FIG. 3, the portable terminal 300 previously stores the distance 330 between the portable terminal 300 and the subject 310, with respect to the lens movement distance 320, in a foam of a look-up table 340. Upon photographing of the subject 310, the portable terminal 300 may receive auto focus information from a camera module and determine the lens movement distance using the auto focus information.

If it is determined that the lens is moved by a distance “C” upon photographing of the subject 310, the portable terminal 300 may determine from the look-up table that the distance between portable terminal 300 and the subject 310 is 3 meters. In addition, if it is determined that the lens is moved by a distance “A” upon photographing of the subject 310′, the portable terminal 300 may determine from the look-up table that the distance between portable terminal 300 and the subject 310 is 1 meter. If it is determined that the lens is moved by a distance “D” upon photographing of the subject 310, the portable terminal 300 may determine from the look-up table that the distance between portable terminal 300 and the subject 310 is 4 meters.

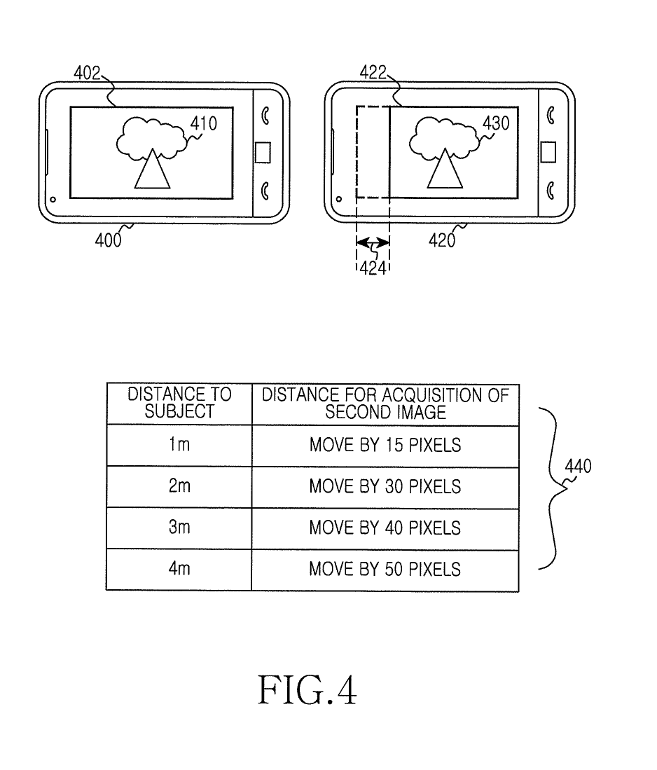

FIG. 4 illustrates an example process of photographing a first image and a second image so as to generate a 3D image providing a 3D effect in the portable terminal according to an embodiment of the present disclosure.

Referring to FIG. 4, the portable terminal will photograph a plurality of images to generate a 3D image.

The images are substantially identical to images generated when the same subject is photographed at different positions, and the image acquired by normal photographing is defined as a first image.

After acquiring a first image, the portable terminal acquires a second image that is photographed at a different position that corresponds to a right viewpoint, and generates a 3D image using the two images. Conventional methods for generating the 3D image using the images photographed at different positions may be use two camera modules. However, the portable terminal according to the embodiment of the present disclosure can generate the 3D image by acquiring two images at different positions using a single camera module.

In order to generate the 3D image the portable terminal determines a position for acquisition of the second image after acquiring the first image. The position for acquisition of the second image is a position at which the second image has a different viewpoint to provide a 3D effect. The portable terminal can determine the position for acquisition of the second image using position information with respect to the actual distance to the subject, which is previously stored in a form of a look-up table, such as look-up table 440.

For example, if it is determined that the distance between the portable terminal 400 and the subject is 3 meters, the portable terminal can acquire the second image generated by photographing the subject at a position moved by 40 pixels, using the previously stored position information 440 with respect to the distance to the subject. That is, the portable terminal 400 acquires the second image after moving the first image by 40 pixels on the preview.

At this time, the portable terminal 400 may photograph a subject 410 with respect to the first image using a photographing region 402. Thereafter, the portable terminal 420 may move the photographing region by 40 pixels, as indicated by reference numeral 424, and take a photograph for acquisition of the second image when the subject 430 is located in the moved photographing region 422.

The first image and the second image acquired in the above manner may includes images that are generated by photographing the same subject with different viewpoints due to different photographing positions.

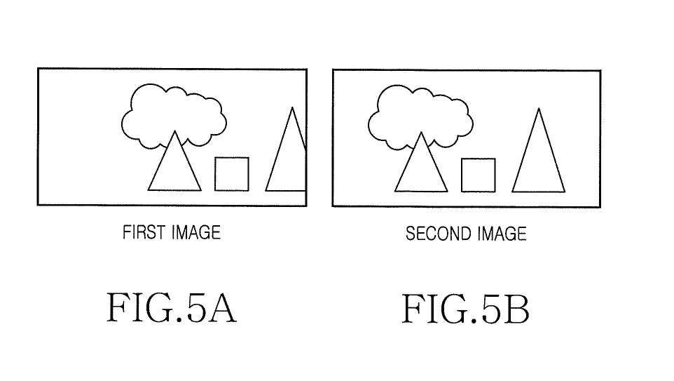

FIGS. 5A and 5B illustrate example images photographed for providing a 3D effect by the portable terminal according to the embodiment of the present disclosure.

Referring to FIGS. 5A and 5B, the portable terminal acquires two images having different view points using a single camera module.

The photographing position of the second image is changed according to the actual distance between the portable terminal and the subject. It can be seen that the first image of FIG. 5A corresponding to the left viewpoint and the second image of FIG. 5B corresponding to the right viewpoint have a viewpoint difference, as in the case of images acquired by simultaneously photographing the subject using two cameras.

As described above, the embodiments of the present invention are directed to acquire a plurality of images having different viewpoints in the portable terminal with a single camera module. Using the actual distance to the subject, a position for acquisition of an image having a different viewpoint is determined. In this manner, it is possible to obtain a 3D effect as if a 3D image is generated by a portable terminal having a plurality of cameras.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for generating an image in a portable terminal, the apparatus comprising:
a camera unit provided with a single camera module that is configured to acquire a first image corresponding to one of a complementary left or right viewpoint and a second image corresponding to the other complementary left or right viewpoint; and
an image generating unit configured to:
determine a photographing region of the second image corresponding to the complementary viewpoint based on the first image; and
acquire the second image in the determined photographing region of the second image using the camera module.

2. The apparatus of claim 1, wherein the image generating unit is configured to determine an actual distance between the portable terminal and a subject corresponding to the first image, and determine the photographing position of the second image using the determined distance.

3. The apparatus of claim 2, wherein the image generating unit is configured to determine the actual distance between the portable terminal and the subject using a look-up table comprising a distance to the subject according to a lens movement distance.

4. The apparatus of claim 2, wherein the image generating unit is configured to determine the photographing position of the second image using information on distance for acquisition of the second image according to the distance to the subject.

5. The apparatus of claim 1, wherein the image generating unit is configured to display a virtual photographing region on a preview screen to represent the determined photographing position of the second image, and acquire the second image when the subject is located in the virtual photographing region.

6. The apparatus of claim 5, wherein the image generating unit is configured to automatically photograph the subject when it is determined that the subject is located in the virtual photographing region using a block matching technique.

7. The apparatus of claim 1, wherein the first image and the second image are acquired using the single camera module and have different viewpoints with respect to the same subject.

8. A method for generating a 3D image in a portable terminal, the method comprising:
acquiring a first image corresponding to one of a complementary left or right viewpoint using a single camera module;
determining a photographing region of a second image corresponding to the complementary right or left viewpoint, based on the first image; and
acquiring the second image in the determined photographing region of the second image.

9. The method of claim 8, wherein the determining of the photographing region of the second image comprises:
determining an actual distance between the portable terminal and the subject corresponding to the first image; and
determining a photographing position of the second image using the determined actual distance.

10. The method of claim 9, wherein the determining of the photographing region of the second image comprises determining the actual distance between the portable terminal and the subject using a look-up table comprising a distance to the subject according to a lens movement distance.

11. The method of claim 9, wherein the photographing position of the second image is determined using information associated with a distance for acquisition of the second image according to the distance to the subject.

12. The method of claim 8, wherein the acquiring of the second image comprises:
displaying a virtual photographing region on a preview screen to represent the determined photographing position of the second image; and
acquiring the second image when the subject is located in the virtual photographing region.

13. The method of claim 12, wherein the acquiring of the second image comprises automatically photographing the subject after it is determined that the subject is located in the virtual photographing region using a block matching technique.

14. The method of claim 8, wherein the first image and the second image are acquired using the single camera module and have different viewpoints with respect to the same subject.

15. An apparatus for generating an image in a portable terminal, the apparatus comprising:
an image generating unit configured to:
receive a first image corresponding to one of a complementary left or right viewpoint and a second image corresponding to the other complementary left or right viewpoint, the first image and the second image acquired by a single camera module;
determine a photographing region of the second image corresponding to the complementary viewpoint based on the first image; and
acquire the second image in the determined photographing region of the second image using the camera module.

16. The apparatus of claim 15, wherein the image generating unit is configured to determine an actual distance between the portable terminal and a subject corresponding to the first image, and determine the photographing position of the second image using the determined distance.

17. The apparatus of claim 16, wherein the image generating unit is configured to determine the actual distance between the portable terminal and the subject using a look-up table comprising a distance to the subject according to a lens movement distance.

18. The apparatus of claim 2, wherein the image generating unit is configured to determine the photographing position of the second image using information on distance for acquisition of the second image according to the distance to the subject.

19. The apparatus of claim 15, wherein the image generating unit is configured to display a virtual photographing region on a preview screen to represent the determined photographing position of the second image, and acquire the second image when the subject is located in the virtual photographing region.

20. The apparatus of claim 19, wherein the image generating unit is configured to automatically photograph the subject when it is determined that the subject is located in the virtual photographing region using a block matching technique.
